(19) United States
(12) Patent Application Publication
(10) Pub. No.: US 2025/0100938 A1
(43) Pub. Date: Mar. 27, 2025

(54) POLYMER DERIVED CERAMICS AND PROCESSES FOR MAKING POLYMER DERIVED CERAMICS

(71) Applicants: Timothy PRUYN, Wright Patterson AFB, OH (US); Matthew DICKERSON, Wright Patterson AFB, OH (US); Kara MARTIN, Wright Patterson AFB, OH (US); Ohio State Innovation Foundation, Columbus, OH (US); Government of the United States, as represented by the Secretary of the Air Force, Wright Patterson AFB, OH (US)

(72) Inventors: Timothy PRUYN, Wright Patterson AFB, OH (US); Matthew DICKERSON, Wright Patterson AFB, OH (US); Kara MARTIN, Wright Patterson AFB, OH (US); Vicky Doan-Nguyen TRIGG, Columbus, OH (US); Patricia LOUGHNEY, Columbus, OH (US)

(21) Appl. No.: 18/832,232

(22) PCT Filed: Jan. 24, 2023
(86) PCT No.: PCT/US2023/061133

§ 371 Date: Jul. 23, 2024

Related U.S. Application Data
(60) Provisional application No. 63/302,382, filed on Jan. 24, 2022.

(51) Int. Cl. C04B 35/524; C04B 35/626

(52) U.S. Cl. CPC C04B 35/524; C04B 35/6267; C04B 35/62675; C04B 2235/3281; C04B 2235/483; C04B 2235/528; C04B 2235/5292; C04B 2235/5445; C04B 2235/5454

(57) ABSTRACT

Disclosed herein are polymer derived ceramics and methods of making the same. The ceramics may be obtained by first thermolyzing a composition including a pre-ceramic polymer and metal salt, and further subjecting the thermolysis step to a pyrolysis step.

### CROSS-REFERENCE TO RELATED APPLICATIONS

This application claims the benefit of priority to U.S. Provisional Application No. 63/302,382 filed Jan. 24, 2022 which is hereby incorporated herein by reference in its entirety.

### STATEMENT OF GOVERNMENT SUPPORT

This invention was made with government support under Grant no. GR119192 awarded by the Air Force Research Southwestern Ohio Council for Higher Education. The government has certain rights in the invention.

### RIGHTS OF THE GOVERNMENT

The invention described herein may be manufactured and used by or for the Government of the United States for all governmental purposes without the payment of any royalty.

### FIELD OF THE INVENTION

The invention is directed to polymer derived ceramics and methods of making polymer derived ceramics. In certain embodiments, the invention is directed to methods of heating a mixture including a pre-ceramic polymer and transition metal to give a polymer derived ceramic.

### BACKGROUND

Breakthroughs in advanced aerospace materials capable of high-temperature operations require innovations in new polymer-derived ceramic (PDC) nanocomposites that provide enhanced functional properties and controlled microstructure. The properties that render PDCs attractive as robust aerospace materials also have significant use and impact in a wide range of applications such as coatings due to high hardness and corrosion and oxidation stability, Li-ion battery electrodes due to high electrical conductivity and large porosity for electrolyte wetting, microelectron mechanical systems devices, and gas and high-temperature sensors.

There remains a need for improved polymer-derived ceramics. There remains a need for improved processes for preparing polymer-derived ceramics. The present invention addresses one or more of these needs.

In accordance with the purposes of the disclosed materials and methods, as embodied and broadly described herein, the disclosed subject matter, in one aspect, relates to compounds, compositions and methods of making and using compounds and compositions.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

The details of one or more embodiments are set forth in the descriptions below. Other features, objects, and advantages will be apparent from the description and from the claims.

### BRIEF DESCRIPTION OF THE FIGURES

FIG. 1 depicts a characterization of the polymer derived ceramic including copper sulfide nanoparticles.

FIG. 2 depicts the formation of copper sulfide nanoparticles in varying amounts of oleylamine.

FIG. 3 depicts SAXS analysis, fits performed using Unifed Model on IREANA following general Guinier-Porod models.

FIG. 4 depicts anisotrophy determination for a polymer derived ceramic. Anisotrophy is increased with increasing relative amounts of PyMPS.

FIG. 5 depicts monitoring of PCP capping using FTIR, showing PyMPS remains mostly intact through synthesis with partial capping of surface through pyridine.

FIG. 6 depicts reaction monitoring using NMR, showing PyMPS acts as reducing agent, not trioctylphosphine or oleylamine.

FIG. 7 depicts (a) Tuning co-ligand ratios control size (confirmed by (b) SAXS) and (c) anisotropic shape. (d) Representative long-chain hydrocarbons.

FIG. 8 depicts the diffusion of Si (blue) into metal (yellow) nanoparticles produces kinetically-driven core-shell heterostructures and voids due to diffusivity mismatch.

FIG. 9 depicts a representative thiol-ene click chemistry to make variety of PCPs such as PyMPS. The area, A, and thickness, t, can be increased with use of end-capped PMPS.

FIG. 10 depicts (a) Steric hindrance of preceramic polymers controls nanostructures' aspect ratio. (b) TEM data confirming plate-like geometries. (c) In-situ SAXS tracks temperature and time of growth with a range of co-ligand concentrations.

FIG. 11 depicts Pair Distribution Function (PDF) analysis of a polymer derived ceramic.

FIG. 12 depicts local ordering of SiO₄₋ₓCₓ moieties in microstructure.

FIG. 13 depicts the structural gradient in a nanofiller.

FIG. 14 depicts a RMC model for fitting PDFs of polymer derived ceramic nanocomposites.

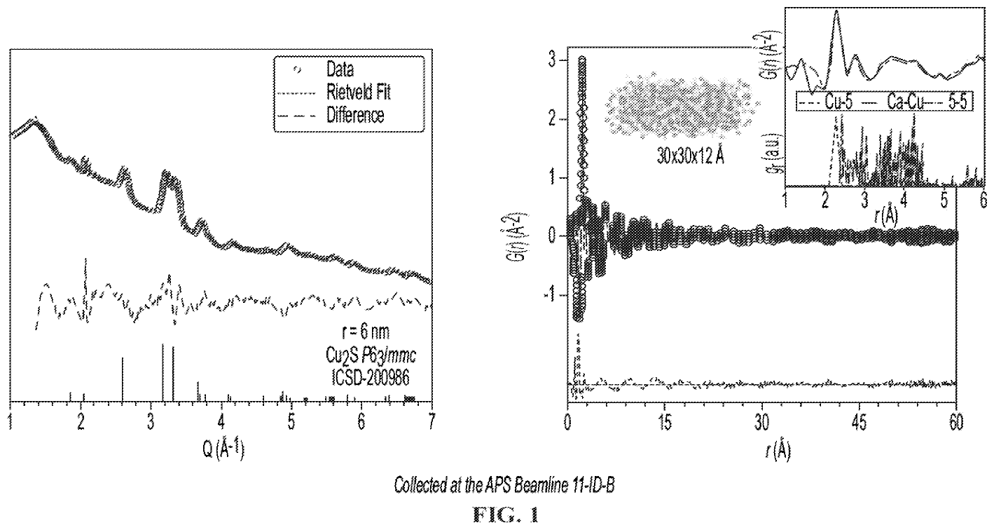

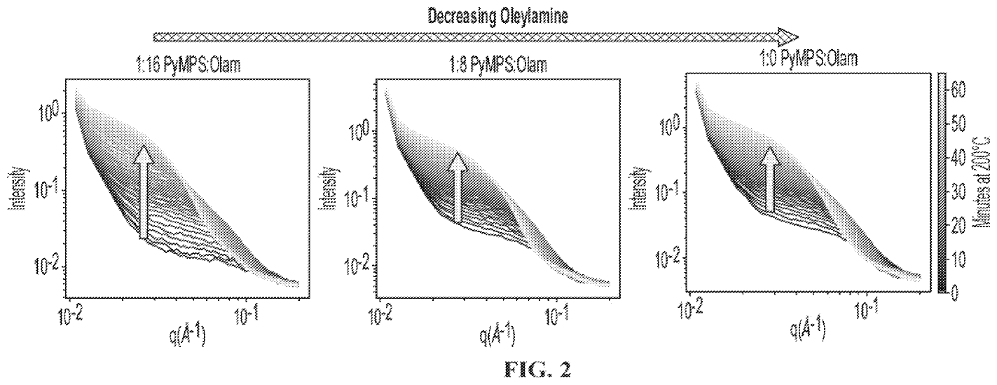

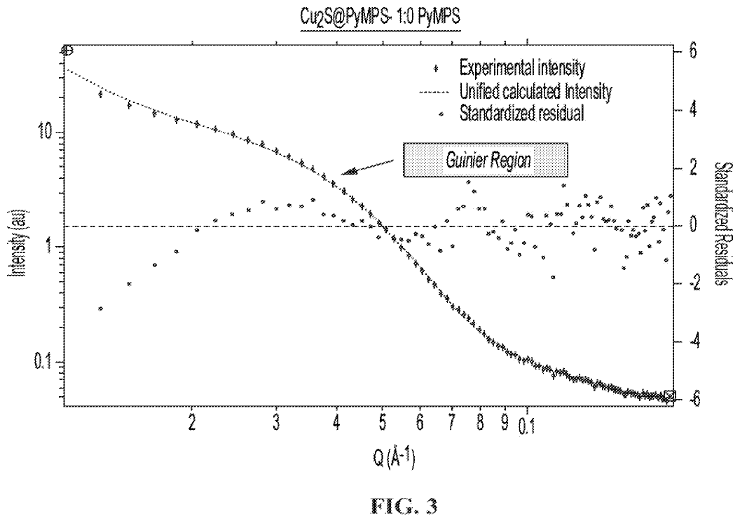

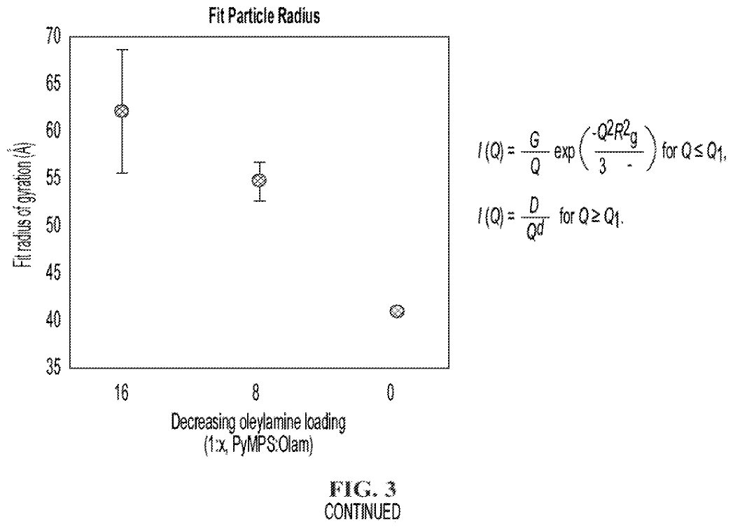

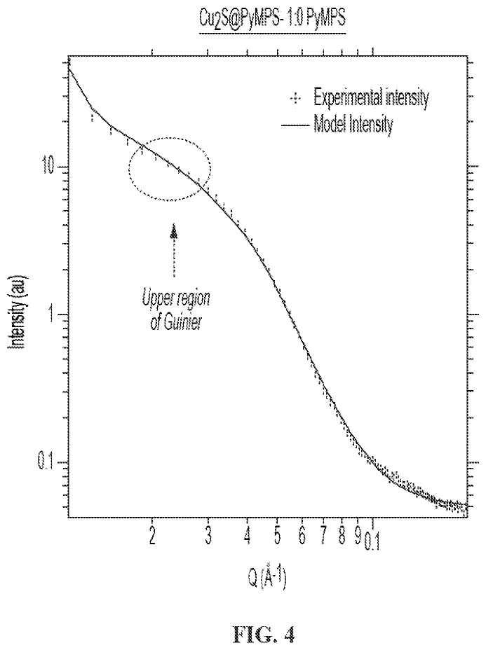

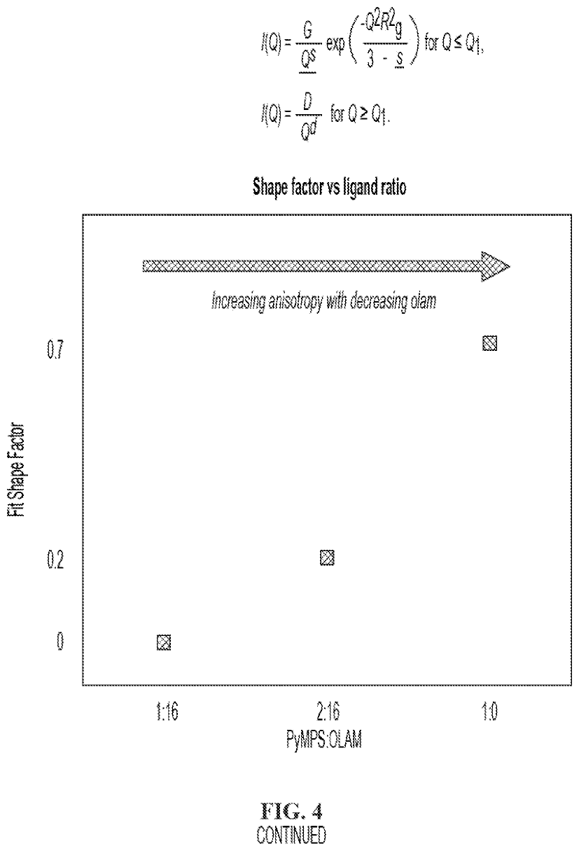

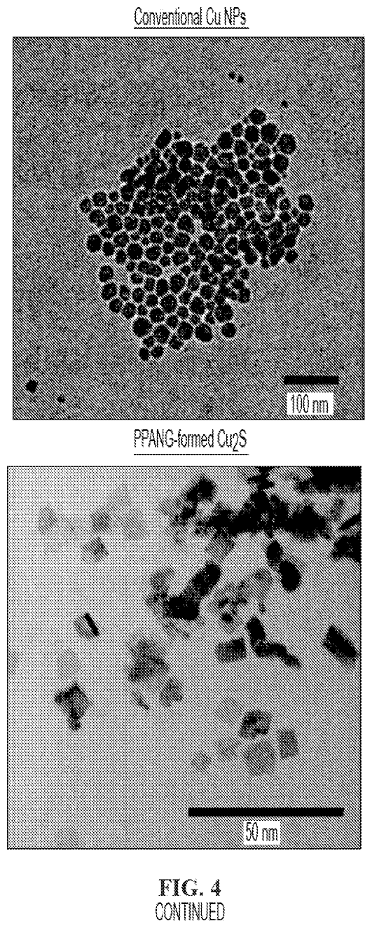

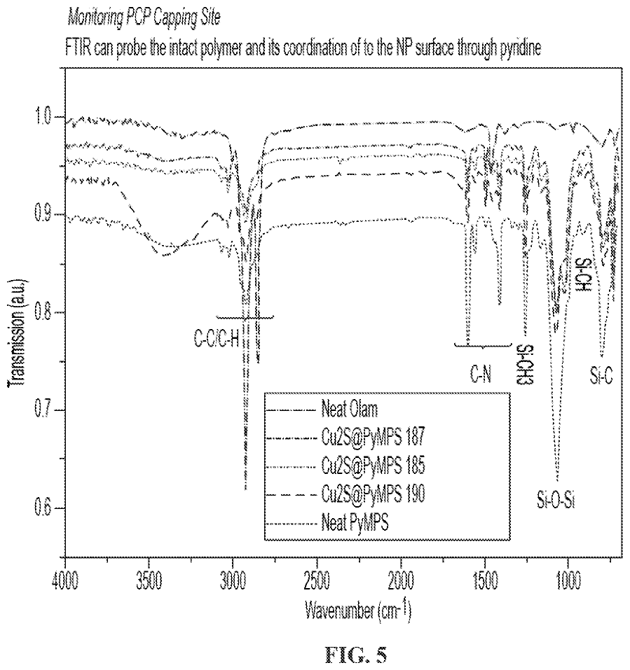

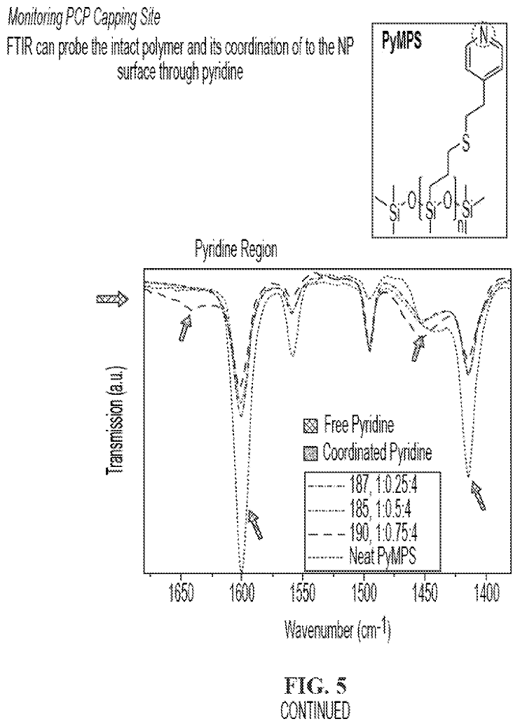

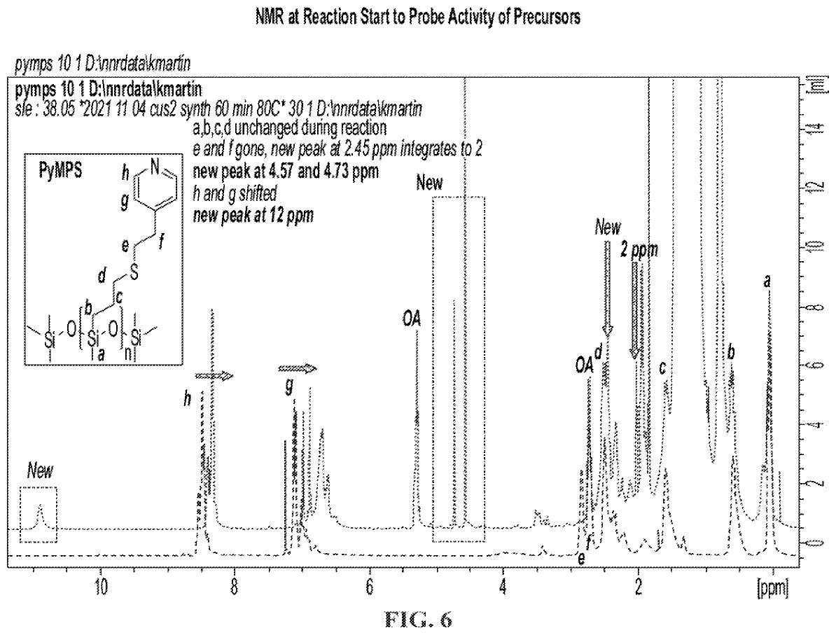

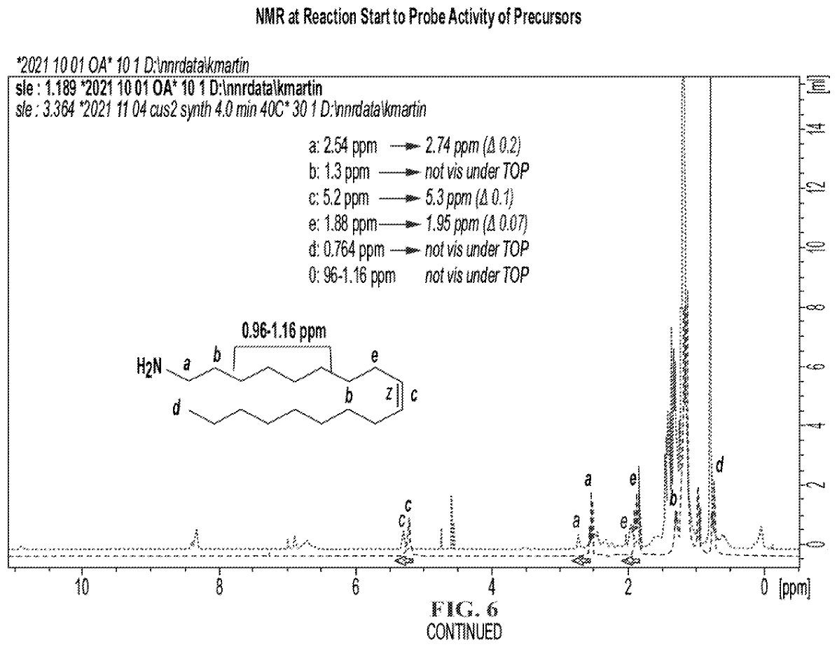

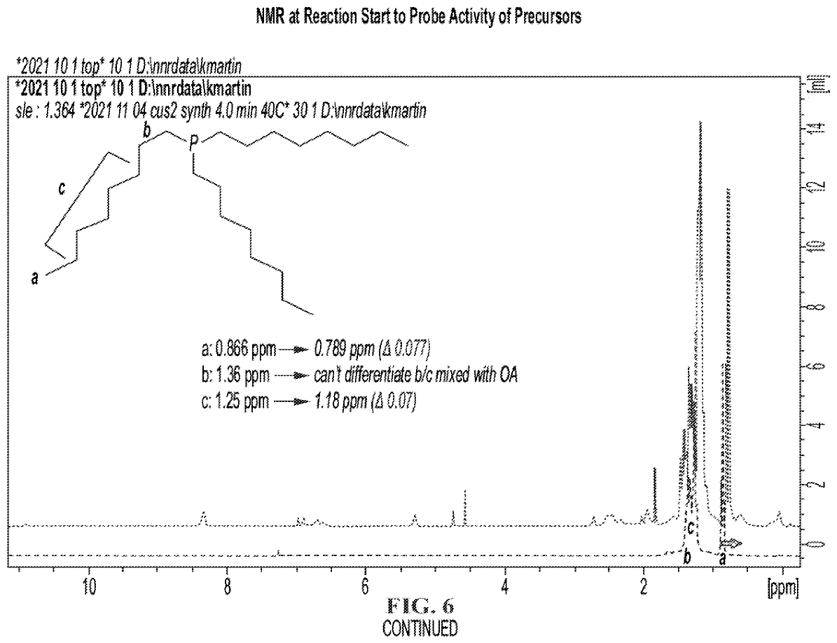

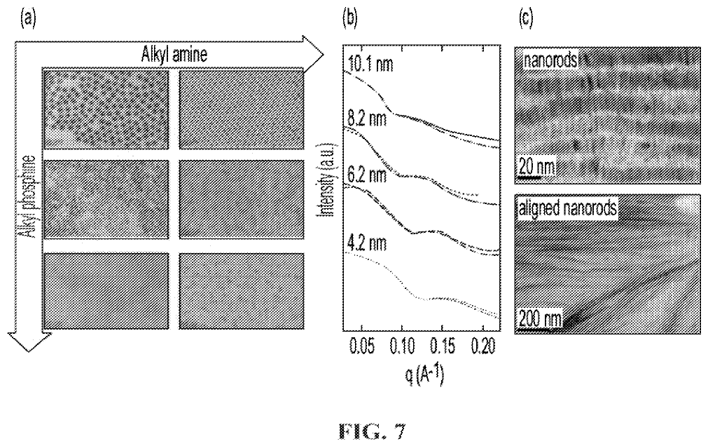

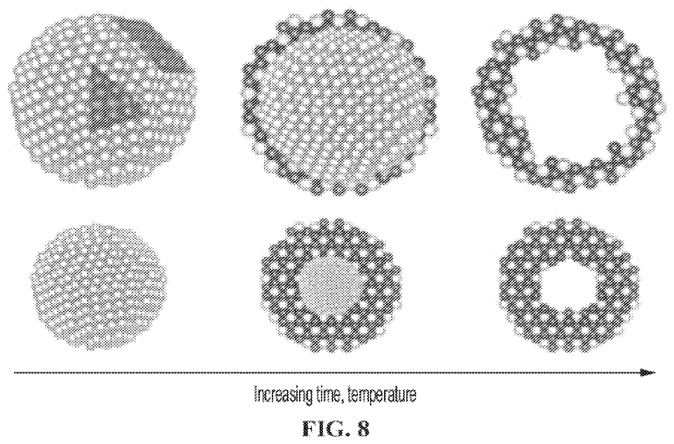

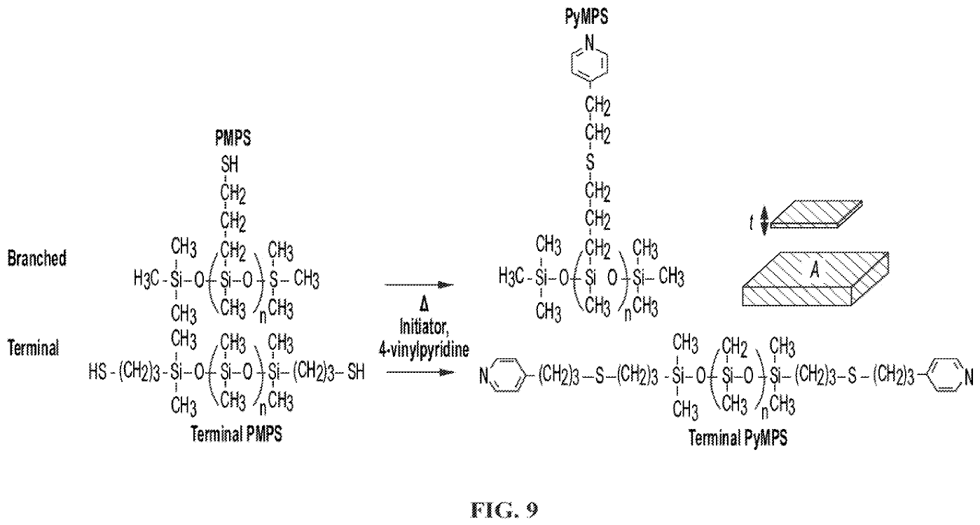

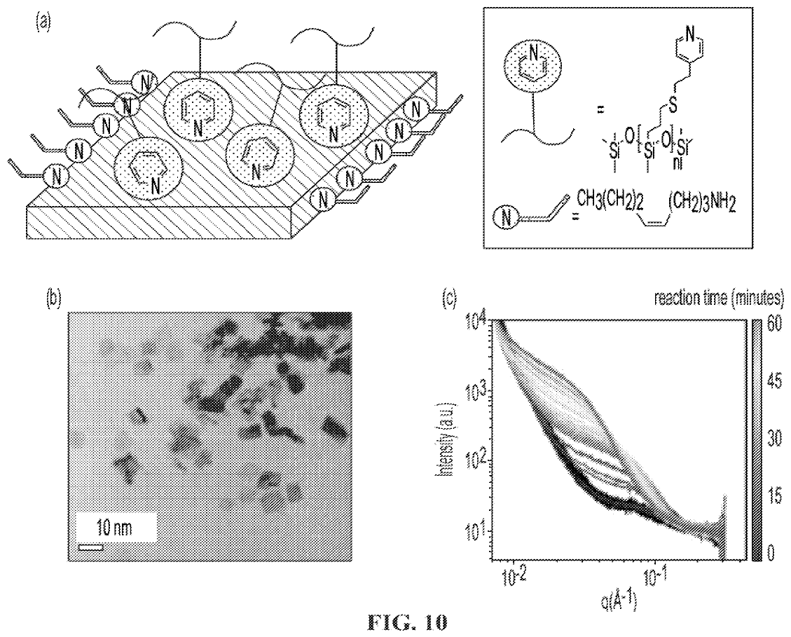

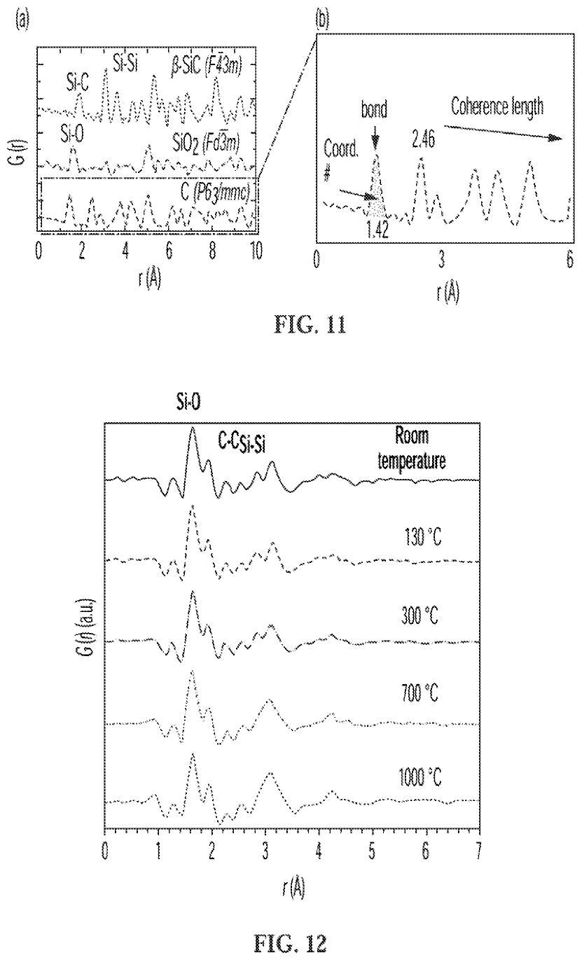

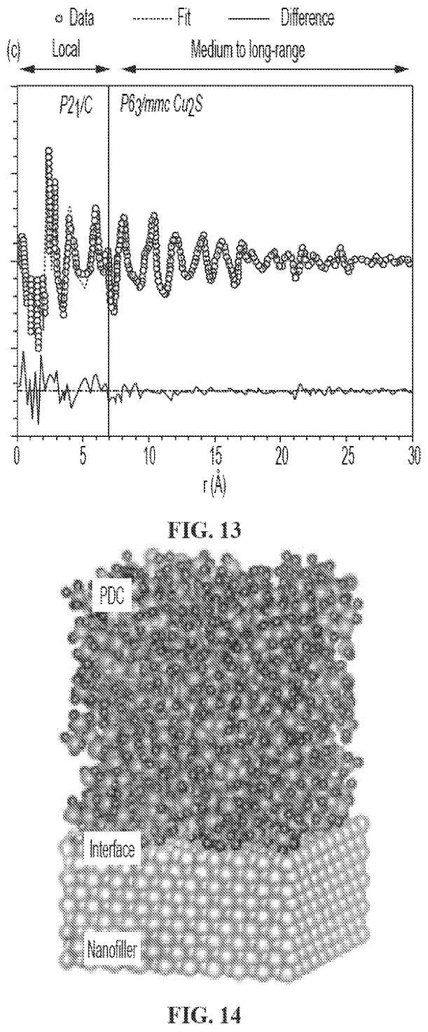

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value.

When such a range is expressed, another embodiment includes, from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions, Wiley Interscience, New York, 1981; Wilen et al., Tetrahedron 33:2725 (1977); Eliel, E. L. Stereochemistry of Carbon Compounds, McGraw-Hill, NY, 1962; and Wilen, S. H., Tables of Resolving Agents and Optical Resolutions p. 268, E. L. Eliel, Ed., Univ. of Notre Dame Press, Notre Dame, IN 1972. The invention additionally encompasses compounds as individual isomers substantially free of other isomers, and alternatively, as mixtures of various isomers.

When a range of values is listed, it is intended to encompass each value and sub-range within the range. For example, “C₁₋₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “alkyl” refers to a radical of a straight-chain or branched saturated hydrocarbon group having a specified range of carbon atoms (e.g., a “C₁₋₁₆ alkyl” can have from 1 to 16 carbon atoms). In some embodiments, an alkyl group has 1 to 9 carbon atoms (“C₁₋₉ alkyl”). In some embodiments, an alkyl group has 1 to 8 carbon atoms (“C₁₋₅ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₅), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆ alkyl, e.g., —CF₃, Bn).

The term “alkylenyl” refers to a divalent radical of a straight-chain, cyclic, or branched saturated hydrocarbon group having a specified range of carbon atoms (e.g., a “C₁₋₁₆ alkyl” can have from 1 to 16 carbon atoms). An example of alkylenyl is a methylene (—CH₂—). An alkylenyl can be substituted as described above for an alkyl.

The term “haloalkyl” is a substituted alkyl group, wherein one or more of the hydrogen atoms are independently replaced by a halogen, e.g., fluoro, bromo, chloro, or iodo. In some embodiments, the haloalkyl moiety has 1 to 8 carbon atoms (“C₁₋₈ haloalkyl”). In some embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). Examples of haloalkyl groups include —CHF₂, —CH₂F, —CF₃, —CH₂CF₃, —CF₂CF₃, —CF₂CF₂CF₃, —CCl₃, —CFCl₂, —CF₂Cl, and the like.

The term “hydroxyalkyl” is a substituted alkyl group, wherein one or more of the hydrogen atoms are independently replaced by a hydroxyl. In some embodiments, the hydroxyalkyl moiety has 1 to 8 carbon atoms (“C₁₋₈ hydroxyalkyl”). In some embodiments, the hydroxyalkyl moiety has 1 to 6 carbon atoms (“C₁₋₆ hydroxyalkyl”). In some embodiments, the hydroxyalkyl moiety has 1 to 4 carbon atoms (“C₁₋₄ hydroxyalkyl”). In some embodiments, the hydroxyalkyl moiety has 1 to 3 carbon atoms (“C₁₋₃ hydroxyalkyl”). In some embodiments, the hydroxyalkyl moiety has 1 to 2 carbon atoms (“C₁₋₂ hydroxyalkyl”).

The term “alkoxy” refers to an alkyl group, as defined herein, appended to the parent molecular moiety through an oxygen atom. In some embodiments, the alkoxy moiety has 1 to 8 carbon atoms (“C₁₋₅ alkoxy”). In some embodiments, the alkoxy moiety has 1 to 6 carbon atoms (“C₁₋₆ alkoxy”). In some embodiments, the alkoxy moiety has 1 to 4 carbon atoms (“C₁₋₄ alkoxy”). In some embodiments, the alkoxy moiety has 1 to 3 carbon atoms (“C₁₋₃ alkoxy”). In some embodiments, the alkoxy moiety has 1 to 2 carbon atoms (“C₁₋₂ alkoxy”). Representative examples of alkoxy include, but are not limited to, methoxy, ethoxy, propoxy, 2-propoxy, butoxy and tert-butoxy.

The term “haloalkoxy” refers to a haloalkyl group, as defined herein, appended to the parent molecular moiety through an oxygen atom. In some embodiments, the alkoxy moiety has 1 to 8 carbon atoms (“C₁₋₈ haloalkoxy”). In some embodiments, the alkoxy moiety has 1 to 6 carbon atoms (“C₁₋₆ haloalkoxy”). In some embodiments, the alkoxy moiety has 1 to 4 carbon atoms (“C₁₋₄ haloalkoxy”). In some embodiments, the alkoxy moiety has 1 to 3 carbon atoms (“C₁₋₃ haloalkoxy”). In some embodiments, the alkoxy moiety has 1 to 2 carbon atoms (“C₁₋₂ haloalkoxy”). Representative examples of haloalkoxy include, but are not limited to, difluoromethoxy, trifluoromethoxy, and 2,2,2-trifluoroethoxy.

The term “alkoxyalkyl” is a substituted alkyl group, wherein one or more of the hydrogen atoms are independently replaced by an alkoxy group, as defined herein. In some embodiments, the alkoxyalkyl moiety has 1 to 8 carbon atoms (“C₁₋₈ alkoxyalkyl”). In some embodiments, the alkoxyalkyl moiety has 1 to 6 carbon atoms (“C₁₋₆ alkoxyalkyl”). In some embodiments, the alkoxyalkyl moiety has 1 to 4 carbon atoms (“C₁₋₄ alkoxyalkyl”). In some embodiments, the alkoxyalkyl moiety has 1 to 3 carbon atoms (“C₁₋₃ alkoxyalkyl”). In some embodiments, the alkoxyalkyl moiety has 1 to 2 carbon atoms (“C₁₋₂ alkoxyalkyl”).

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkyl group refers to a saturated group having from 1 to 20 carbon atoms and 1 or more heteroatoms within the parent chain (“heteroC₁₋₂₀ alkyl”). In some embodiments, a heteroalkyl group is a saturated group having 1 to 18 carbon atoms and 1 or more heteroatoms within the parent chain (“heteroC₁₋₁₈ alkyl”). In some embodiments, a heteroalkyl group is a saturated group having 1 to 16 carbon atoms and/or more heteroatoms within the parent chain (“heteroC₁₋₁₆ alkyl”). In some embodiments, a heteroalkyl group is a saturated group having 1 to 14 carbon atoms and 1 or more heteroatoms within the parent chain (“heteroC₁₋₁₄ alkyl”). In some embodiments, a heteroalkyl group is a saturated group having 1 to 12 carbon atoms and 1 or more heteroatoms within the parent chain (“heteroC₁₋₁₂ alkyl”). In some embodiments, a heteroalkyl group is a saturated group having 1 to 10 carbon atoms and 1 or more heteroatoms within the parent chain (“heteroC₁₋₁₀ alkyl”). In some embodiments, a heteroalkyl group is a saturated group having 1 to 8 carbon atoms and 1 or more heteroatoms within the parent chain (“heteroC₁₋₅ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1 to 2 carbon atoms and 1 heteroatom within the parent chain (“heteroC₁₋₂ alkyl”). In some embodiments, a heteroalkyl group is a saturated group having 1 carbon atom and 1 heteroatom (“heteroC₁ alkyl”). In some embodiments, the heteroalkyl group defined herein is a partially unsaturated group having 1 or more heteroatoms within the parent chain and at least one unsaturated carbon, such as a carbonyl group. For example, a heteroalkyl group may comprise an amide or ester functionality in its parent chain such that one or more carbon atoms are unsaturated carbonyl groups. Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₂₀ alkyl. In certain embodiments, the heteroalkyl group is an unsubstituted heteroC₁₋₁₀ alkyl. In certain embodiments, the heteroalkyl group is a substituted heteroC₁₋₂₀ alkyl. In certain embodiments, the heteroalkyl group is an unsubstituted heteroC₁₋₁₀ alkyl.

The term “alkenyl” refers to a radical of a straight-chain or branched hydrocarbon group having from 2 to 10 carbon atoms and one or more carbon-carbon double bonds (e.g., 1, 2, 3, or 4 double bonds). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl. In an alkenyl group, a C═C double bond for which the stereochemistry is not specified (e.g., —CH═CHCH₃ or

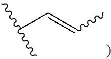

may be an (E)- or (Z)-double bond.

The term “heteroalkenyl” refers to an alkenyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”).

In some embodiments, a heteroalkenyl group has 2 to 8 carbon atoms, at least one double bond, and 1 or more heteroatoms within the parent chain (“heteroC₂₋₈ alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂₋₅ alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

The term “alkynyl” refers to a radical of a straight-chain or branched hydrocarbon group having from 2 to 10 carbon atoms and one or more carbon-carbon triple bonds (e.g., 1, 2, 3, or 4 triple bonds) (“C₂₋₁₀ alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂₋₈ alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”). In some embodiments, a heteroalkynyl group has 2 to 4 carbon atoms, at least one triple bond, and 1 or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

The term “carbocyclyl” or “carbocyclic” refers to a radical of a non-aromatic cyclic hydrocarbon group having from 3 to 14 ring carbon atoms (“C₃₋₁₄ carbocyclyl”) and zero heteroatoms in the non-aromatic ring system. In some embodiments, a carbocyclyl group has 3 to 10 ring carbon atoms (“C₃₋₁₀ carbocyclyl”). In some embodiments, a carbocyclyl group has 3 to 8 ring carbon atoms (“C₃₋₈ carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 4 to 6 ring carbon atoms (“C₄₋₆ carbocyclyl”). In some embodiments, a carbocyclyl group has 5 to 6 ring carbon atoms (“C₅₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like.

Exemplary C₃₋₈ carbocyclyl groups include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include, without limitation, the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₄ carbocyclyl. In certain embodiments, the carbocyclyl group is a substituted C₃₋₁₄ carbocyclyl.

In some embodiments, “carbocyclyl” is a monocyclic, saturated carbocyclyl group having from 3 to 14 ring carbon atoms (“C₃₋₁₄ cycloalkyl”). In some embodiments, a cycloalkyl group has 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅₋₆ cycloalkyl groups include cyclopentyl (C₅) and cyclohexyl (C₆). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₄ cycloalkyl. In certain embodiments, the cycloalkyl group is a substituted C₃₋₁₄ cycloalkyl.

As used herein, the term “heterocyclyl” refers to an aromatic (also referred to as a heteroaryl), unsaturated, or saturated cyclic hydrocarbon that includes at least one heteroatom in the cycle. For example, the term “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

Exemplary 3-membered heterocyclyl groups containing 1 heteroatom include, without limitation, aziridinyl, oxiranyl, and thiiranyl. Exemplary 4-membered heterocyclyl groups containing 1 heteroatom include, without limitation, azetidinyl, oxetanyl, and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 3 heteroatoms include, without limitation, triazinyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

The term “aryl” refers to a radical of a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

“Aralkyl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include, without limitation, pyrrolyl, furanyl, and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl, and phenazinyl.

“Heteroaralkyl” is a subset of “alkyl” and refers to an alkyl group substituted by a heteroaryl group, wherein the point of attachment is on the alkyl moiety.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

A group is optionally substituted unless expressly provided otherwise. The term “optionally substituted” refers to being substituted or unsubstituted. In certain embodiments, alkyl, alkenyl, alkynyl, heteroalkyl, heteroalkenyl, heteroalkynyl, carbocyclyl, heterocyclyl, aryl, and heteroaryl groups are optionally substituted. “Optionally substituted” refers to a group which may be substituted or unsubstituted (e.g., “substituted” or “unsubstituted” alkyl, “substituted” or “unsubstituted” alkenyl, “substituted” or “unsubstituted” alkynyl, “substituted” or “unsubstituted” heteroalkyl, “substituted” or “unsubstituted” heteroalkenyl, “substituted” or “unsubstituted” heteroalkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not intended to be limited in any manner by the exemplary substituents described herein.

Exemplary carbon atom substituents include, but are not limited to, halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR—, —SSR^{cc}, —C(═O)R^{aa}, —CO₂H, —CHO, —C(OR^{cc})₃, —CO₂R^{aa}, —OC(═O)R^{aa}, —OCO₂R^{aa}, —C(═O)N(R^{bb})₂, —OC(═O)N(R^{bb})₂, —NR^{bb}C(═O)R^{aa}, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃, —C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{cc})₂, —P(═O)(N(R^{bb})₂)₂, —OP(═O)(N(R^{bb})₂)₂, —NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃⁺X⁻, —P(OR^{cc})₃⁺X⁻, —P(R^{cc})₄, —P(OR^{cc})₂, —OP(R^{cc})₂, —OP(R^{cc})₃⁺X⁻, —OP(OR^{cc})₂, —OP(OR^{cc})₃⁺X⁻, —OP(R^{cc})₄, —OP(OR^{cc})₄, —B(R^{aa})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion; or two geminal hydrogens on a carbon atom are replaced with the group ═O, ═S, ═NN(R^{bb})₂, —NNR^{bb}C(═O)R^{aa}, —NNR^{bb}C(═O)OR^{aa}, —NNR^{bb}S(═O)₂R^{aa}, ═NR^{bb} or ═NOR^{cc}; each instance of R^{aa} is, independently, selected from C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂, —P(═O)(OR^{cc})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion; each instance of R^{cc} is, independently, selected from hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ee}C(═O)N(R^{ff})₂, —C(═NR^{ff})OR^{ee}, —OC(═NR^{ff})R^{ee}, —OC(═NR^{ee})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ee})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S; wherein X⁻ is a counterion; each instance of R^{ee} is, independently, selected from C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; each instance of R^{f} is, independently, selected from hydrogen, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl and 5-10 membered heteroaryl, or two R^{ff} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)2⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(═NH)NH(C₁₋₆ alkyl), —OC(═NH)NH₂, —NHC(═NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂(C₁₋₆ alkyl), —SO₂O(C₁₋₆ alkyl), —OSO₂(C₁₋₆ alkyl), —SO(C₁₋₆ alkyl), —Si(C₁₋₆ alkyl)₃, —OSi(C₁₋₆ alkyl)₃, —C(═S)N(C₁₋₆ alkyl)₂, —C(═S)NH(C₁₋₆ alkyl), —C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, 5-10 membered heteroaryl; or two geminal R^{gg} substituents can be joined to form ═O or ═S; wherein X⁻ is a counterion.

The term “halo” or “halogen” refers to fluorine (fluoro, —F), chlorine (chloro, —Cl), bromine (bromo, —Br), or iodine (iodo, —I).

The term “hydroxyl” or “hydroxy” refers to the group —OH. The term “substituted hydroxyl” or “substituted hydroxyl,” by extension, refers to a hydroxyl group wherein the oxygen atom directly attached to the parent molecule is substituted with a group other than hydrogen, and includes groups selected from —OR^{aa}, —ON(R^{bb})₂, —OC(═O)SR^{aa}, —OC(═O)R^{aa}, —OCO₂R^{aa}, —OC(═O)N(R^{bb})₂, —OC(═NR^{bb})R^{aa}, —OC(═NR^{bb})OR^{aa}, —OC(═NR^{bb})N(R^{bb})₂, —OS(═O)R^{aa}, —OSO₂R^{aa}, —OSi(R^{aa})₃, —OP(R^{cc})₂, —OP(R^{cc})₃⁺X⁻, —OP(OR^{cc})₂, —OP(OR^{cc})₃⁺X⁻, —OP(═O)(R^{aa})₂, —OP(═O)(ORC)₂, and —OP(═O)(N(R^{bb})₂)₂, wherein X⁻, R^{aa}, R^{bb} and R^{cc} are as defined herein.

The term “amino” refers to the group —NH₂. The term “substituted amino,” by extension, refers to a monosubstituted amino, a disubstituted amino, or a trisubstituted amino. In certain embodiments, the “substituted amino” is a monosubstituted amino or a disubstituted amino group.

The term “monosubstituted amino” refers to an amino group wherein the nitrogen atom directly attached to the parent molecule is substituted with one hydrogen and one group other than hydrogen, and includes groups selected from —NH(R^{bb}), —NHC(═O)R^{aa}, —NHCO₂R^{aa}, —NHC(═O)N(R^{bb})₂, —NHC(═NR^{bb})N(R^{bb})₂, —NHSO₂R^{aa}, —NHP(═O)(OR^{cc})₂, and —NHP(═O)(N(R^{bb})₂)₂, wherein R^{aa}, R^{bb}, and R^{cc} are as defined herein, and wherein R^{bb} of the group —NH(R^{bb}) is not hydrogen.

The term “disubstituted amino” refers to an amino group wherein the nitrogen atom directly attached to the parent molecule is substituted with two groups other than hydrogen, and includes groups selected from —N(R^{bb})₂, —NR^{bb}C(═O)R^{aa}, —NR^{bb}CO₂R, —NR^{bb}C(═O)N(R^{bb})₂, —NR^{bb}C(═NR^{bb})N(R^{bb})₂, —NR^{bb}SO₂R^{aa}, —NR^{bb}P(═O)(OR^{cc})₂, and —NR^{bb}P(═O)(N(R^{bb})₂)₂, wherein R^{aa}, R^{bb}, and R^{cc} are as defined herein, with the proviso that the nitrogen atom directly attached to the parent molecule is not substituted with hydrogen.

The term “trisubstituted amino” refers to an amino group wherein the nitrogen atom directly attached to the parent molecule is substituted with three groups, and includes groups selected from —N(R^{bb})₂ and —N(R^{bb})₃⁺X⁻, wherein R^{bb} and X⁻ are as defined herein.

The term “sulfonyl” refers to a group selected from —SO₂N(R^{bb})₂, —SO₂R^{aa}, and SO₂OR^{aa}, wherein R^{aa} and R^{bb} are as defined herein.

The term “sulfinyl” refers to the group —S(═O)R^{a}, wherein R^{aa} is as defined herein.

The term “acyl” refers to a group having the general formula —C(═O)R^{X1}, —C(═O)OR^{X1}, —C(═O)—O—C(═O)R^{X1}, —C(═O)SR^{X1}, —C(═O)N(R^{X1})₂, —C(═S)R^{X1}, —C(═S)N(R^{X1})₂, —C(═S)O(R^{X1}), —C(═S)S(R^{X1}), —C(═NR^{X1})R^{X1}, —C(═NR^{X1})OR^{X1}, —C(═NR^{X1})SR^{X1}, and —C(═NR^{X1})N(R^{X1})₂, wherein R^{X1} is hydrogen; halogen; substituted or unsubstituted hydroxyl; substituted or unsubstituted thiol; substituted or unsubstituted amino; substituted or unsubstituted acyl, cyclic or acyclic, substituted or unsubstituted, branched or unbranched aliphatic; cyclic or acyclic, substituted or unsubstituted, branched or unbranched heteroaliphatic; cyclic or acyclic, substituted or unsubstituted, branched or unbranched alkyl; cyclic or acyclic, substituted or unsubstituted, branched or unbranched alkenyl; substituted or unsubstituted alkynyl; substituted or unsubstituted aryl, substituted or unsubstituted heteroaryl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, mono- or di-aliphaticamino, mono- or di-heteroaliphaticamino, mono- or dialkylamino, mono- or di-heteroalkylamino, mono- or di-arylamino, or mono- or diheteroarylamino; or two R^{X1} groups taken together form a 5- to 6-membered heterocyclic ring.

Exemplary acyl groups include aldehydes (—CHO), carboxylic acids (—CO₂H), ketones, acyl halides, esters, amides, imines, carbonates, carbamates, and ureas. Acyl substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “carbonyl” refers a group wherein the carbon directly attached to the parent molecule is sp² hybridized, and is substituted with an oxygen, nitrogen or sulfur atom, e.g., a group selected from ketones (e.g., —C(═O)R^{aa}), carboxylic acids (e.g., —CO₂H), aldehydes (CHO), esters (e.g., —CO₂R^{aa}, —C(═O)SR^{aa}, —C(═S)SR^{aa}), amides (e.g., —C(═O)N(R^{bb})₂, C(═O)NR^{bb}SO₂R^{aa}, —C(═S)N(R^{bb})₂, and imines (e.g., —C(═NR^{bb})R^{aa}, —C(═NR^{bb})OR^{aa}), C(═NR^{bb})N(R^{bb})₂, wherein R^{aa} and R^{bb} are as defined herein.

The term “oxo” refers to the group ═O, and the term “thiooxo” refers to the group ═S.

The term “cyano” refers to the group —CN.

The term “azide” refers to the group —N₃.

Nitrogen atoms can be substituted or unsubstituted as valency permits, and include primary, secondary, tertiary, and quaternary nitrogen atoms. Exemplary nitrogen atom substituents include, but are not limited to, hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{bb})R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(OR^{cc})₂, —P(═O)(R^{aa})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups attached to an N atom are joined to form a 3-14 membered heterocyclyl or a 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc}, and R^{dd} are as defined herein.

Disclosed herein are methods of preparing a ceramic matrix, including the steps of subjecting a mixture to a thermolysis step to provide a plurality of nanostructures, and then subjecting the nanostructures to a pyrolysis step to provide a ceramic matrix. In certain embodiments, the thermolysis step comprises a first heating at a first gradient to a first sustained temperature, and then maintaining the temperature at the first sustained temperature for a first period of time.

The first heating gradient can be from 1-15° C./min, from 1-10° C./min, from 1-8° C./min, from 1-5° C./min, from 2-15° C./min, from 2-10° C./min, from 2-8° C./min, from 2-6° C./min, from 5-15° C./min, or from 5-10° C./min. Exemplary first sustained temperatures include from 100-350° C., from 125-350° C., from 150-350° C., from 175-350° C., from 200-350° C., from 225-350° C., from 250-350° C., from 100-300° C., from 100-275° C., from 100-250° C., from 100-225° C., from 100-200° C., from 125-250° C., from 150-250° C., from 150-225° C., from 150-200° C., from 150-175° C., from 175-250° C., from 175-225° C., from 175-200° C., or from 200-225° C.

Exemplary first periods of time include 5-250 minutes, from 10-250 minutes, from 20-250 minutes, from 30-250 minutes, from 30-200 minutes, from 30-150 minutes, from 30-120 minutes, from 30-110 minutes, from 30-100 minutes, from 30-90 minutes, from 40-90 minutes, from 50-90 minutes, from 30-75 minutes, from 30-60 minutes, from 30-45 minutes, from 20-40 minutes, from 15-30 minutes, from 10-25 minutes, from 5-20 minutes, from 5-15 minutes, from 1-10 minutes, from 40-80 minutes, or from 45-75 minutes.

In some embodiments, the thermolysis step can be conducted in an inert atmosphere, an oxidizing atmosphere, carbonizing atmosphere, or a reducing atmosphere. In some instances, the inert atmosphere can be argon or nitrogen gas, the oxidizing atmosphere can be oxygen gas (optionally mixed with one or more inert gases such as argon or nitrogen), the carbonizing atmosphere can be methane gas, ethane gas, ethylene gas, or acetylene gas (optionally mixed with one or more inert gases), and the reducing atmosphere can hydrogen gas (optionally mixed with inert gases). In other embodiments, the thermolysis step can be conducted under a regular atmosphere (e.g., a mix of nitrogen, oxygen, and other minor gases).

The pyrolysis step can include a second heating at a second gradient to a second sustained temperature, and then maintaining the temperature at the second sustained temperature for a second period of time. For example, the second gradient can from 1-15° C./min, from 1-10° C./min, from 1-8° C./min, from 1-5° C./min, from 2-15° C./min, from 2-10° C./min, from 2-8° C./min, from 2-6° C./min, from 5-15° C./min, or from 5-10° C./min.

In certain embodiments, the second sustained temperature can be from 300-1,800° C., from 400-1,800° C., from 500-1,800° C., from 600-1,800° C., from 700-1,800° C., from 800-1,800° C., from 900-1,800° C., from 1,000-1,800° C., from 1,200-1,800° C., from 600-1,500° C., from 600-1,200° C., from 750-1,500° C., from 750-1,200° C., from 900-1,500° C., or from 900-1,200° C.,

Exemplary second periods of time include 5-250 minutes, from 10-250 minutes, from 20-250 minutes, from 30-250 minutes, from 30-200 minutes, from 30-150 minutes, from 30-120 minutes, from 30-110 minutes, from 30-100 minutes, from 30-90 minutes, from 40-90 minutes, from 50-90 minutes, from 30-75 minutes, from 30-60 minutes, from 30-45 minutes, from 20-40 minutes, from 15-30 minutes, from 10-25 minutes, from 5-20 minutes, from 5-15 minutes, from 1-10 minutes, from 40-80 minutes, or from 45-75 minutes.

The pyrolysis step can be conducted in an inert atmosphere, an oxidizing atmosphere, carbonizing atmosphere, or a reducing atmosphere. In some instances, the inert atmosphere can be argon or nitrogen gas, the oxidizing atmosphere can be oxygen gas (optionally mixed with one or more inert gases such as argon or nitrogen), the carbonizing atmosphere can be methane gas, ethane gas, ethylene gas, or acetylene gas (optionally mixed with one or more inert gases), and the reducing atmosphere can hydrogen gas (optionally mixed with inert gases). In other embodiments, the pyrolysis step can be conducted under a regular atmosphere (e.g., a mix of nitrogen, oxygen, and other minor gases).

In some embodiments, the thermolysis and pyrolysis steps can be performed sequentially, i.e., there is no cooling step between the first sustained temperature and the second heating step. In other embodiments, the mixture may be cooled to a temperature lower than the first sustained temperature before commencing the second heating step. For example, the mixture can be cooled to a temperature that is at least 10% less, at least 20% less, at least 30% less, at least 40% less, at least 50% less, at least 60% less, at least 70% less, at least 80% less, or at least 90% less than the first sustained temperature before commencing the second heating step.

In some embodiments the mixture can be cooled to room temperature before commencing the second heating step.

The method disclosed herein can be used to produce nanostructures, which generally include spheres and plates.

When the nanostructures are spheres, the spheres can have an average diameter from 1-500 nm, from 1-250 nm, from 1-200 nm, from 1-150 nm, from 1-100 nm, from 1-75 nm, from 1-50 nm, from 1-25 nm, from 2-25 nm, from 4-25 nm, from 4-20 nm, from 4-15 nm, from 10-25 nm, from 15-50 nm, from 25-75 nm, or from 25-100 nm.

As used herein, the nanostructure plates are characterized by having a length, width and thickness. The aspect ratio is the ratio of width and length; for example, an aspect ratio of 1.5 indicates the plates have an average length that is 1.5× as long as the average width. Exemplary aspect ratios include from 1-3.0, from 1-2.5, from 1-2.25, from 1-2, from 1-1.75, from 1-1.50, from 1-1.40, from 1-1.35, from 1-1.25, from 1.05-1.5, from 1.05-1.25, from 1.05-1.15, from 1.1-1.5, from 1.1-1.25, from 1.1-1.15, from 1.15-1.35, from 1.15-1.3, or from 1.15-1.25.

The nanostructure plates can have a thickness from 1-200 nm, from 1-150 nm, from 1-125 nm, from 1-100 nm, from 1-75 nm, from 1-50 nm, from 1-40 nm, from 1-30 nm, from 1-25 nm, from 1-20 nm, from 1-15 nm, from 1-10 nm, from 1-5 nm, from 5-10 nm, from 5-15 nm, from 5-25 nm, from 10-25 nm, from 10-50 nm, from 25-75 nm, or from 50-100 nm.

The precursor mixture used in the aforementioned heating sequences can include at least one preceramic polymer, and at least one metal salt. Exemplary metal salts include Cu⁺¹, Cu⁺², Hf⁺⁴, Fe⁺¹, Fe⁺², Fe⁺³, Co⁺², Co⁺³, Ni⁺², Ni⁺³, Ni⁺⁴, Nb⁺², Nb⁺³, Nb⁺⁴, Nb⁺⁵, Mo⁺², Mo⁺³, Mo⁺⁴, Mo⁺⁵, and Mo⁺⁶. Preferred metals include Cu⁺² and Hf⁺⁴. Such metals may be provided in one or more of the following compounds: CuCl₂, Cu(acac)₂, CuO, CuSO₄, Cu(OAc)₂, CuCO₃, CuBr₂, Cu₃(PO₄)₂, Cu(OBz)₂, HfCl₄,

The mixture can further include one or more pre-ceramic polymers of Formula (I):

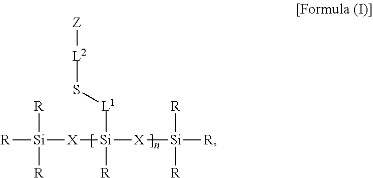

wherein:
R is H, C₁₋₈alkyl, aryl, C₃₋₈cycloalkyl, C₁₋₈heterooalkyl, or C₃₋₈-heteroaryl,
X is null, CH₂, —O—, —N(R¹)—, —B(R²)—, —Si(R)₂CH₂—, —N═C═N—, —O—Si—B(R²)—,
R¹ is independently selected from H, C₁₋₃alkyl, B(R²)₂, and -L¹-S-L²-Z,
R² is independently selected from H, C₁₋₃alkyl, and -L¹-S-L²-Z,
n is selected from 10-500, 10-25, 10-50, 10-100, 100-500, 100-250, 250-500, 25-150, 25-100, 25-75, 25-50, 50-75, or 50-100;
L¹ is in each case independently selected from null, C₁₋₈alkylene, arylene, C₃₋₈cycloalkylene, C₁₋₈heteroarylene, or C₁₋₈heterocyclylene;
L² is in each case independently selected from null, C₁₋₈alkylene, arylene, C₃₋₈cycloalkylene, C₁₋₈heteroarylene, or C₁₋₈heterocyclylene; and
Z is in each case independently selected from Z¹, OZ¹, N(Z¹)₂, C(O)Z¹, C(O)OZ¹, C(O)N(Z¹)₂, where Z¹ is in case selected from H, C₁₋₁₂alkyl, aryl, C₃₋₈cycloalkyl, C₁₋₈heteroaryl, and C₁₋₈heterocyclyl.

Unless specified to the contrary, the mixture can include multiple compounds falling within the scope of Formula (I). For example, a compound of Formula (I) wherein Z is hydrogen and a compound of Formula (I) wherein Z is pyridinyl may be combined.

Preferred R groups include methyl, ethyl, isopropyl, n-propyl, n-butyl, sec-butyl tert-butyl, isobutyl, pentyl, hexyl, cyclopropyl, cyclobutyl, cyclopentyl, cyclohexyl, and phenyl. Especially preferred are compound in which R is methyl.

In some embodiments, the mixture can further include one or more pre-ceramic polymer of Formula (II):

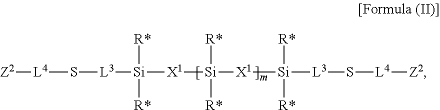

wherein:
R* is H, C₁₋₈alkyl, aryl, C₃₋₈cycloalkyl, C₁₋₈heterooalkyl, or C₃₋₈heteroaryl,
X¹ is null, CH₂, —O—, —N(R³)—, —B(R⁴)—, —Si(R)₂CH₂—, —N═C═N—, —O—Si—B(R⁴)—,
R³ is independently selected from H, C₁₋₃alkyl, and B(R⁴)₂,
R⁴ is H or C₁₋₃alkyl,
m is in each case independently selected from 10-500, 10-25, 10-50, 10-100, 100-500, 100-250, 250-500, 25-150, 25-100, 25-75, 25-50, 50-75, or 50-100;
L³ is in each case independently selected from null, C₁₋₈alkylene, arylene, C₃₋₈cycloalkylene, C₁₋₈heteroarylene, or C₁₋₈heterocyclylene;
L⁴ is in each case independently selected from null, C₁₋₈alkylene, arylene, C₃₋₈cycloalkylene, C₁₋₈heteroarylene, or C₁₋₈heterocyclylene; and
Z² is in each case independently selected from Z³, OZ³, N(Z³)₂, C(O)Z³, C(O)OZ³, C(O)N(Z³)₂, where Z³ is in case selected from H, C₁₋₁₂alkyl, aryl, C₃₋₈cycloalkyl, C₁₋₈heteroaryl, and C₁₋₈heterocyclyl.

Preferred R* groups include H, methyl, ethyl, isopropyl, n-propyl, n-butyl, sec-butyl tert-butyl, isobutyl, pentyl, hexyl, cyclopropyl, cyclobutyl, cyclopentyl, cyclohexyl, and phenyl, preferably R* is methyl.

In certain embodiments, the mixture will not contain any compounds of Formula (II), while in other embodiments, at least one compound of Formula (II) can be present in an amount that is from 0.1-50%, from 0.5-50%, from 1-50%, from 1-25%, from 1-15%, from 1-10%, from 1-5%, from 0.1-1%, from 0.5-5%, from 0.5-2.5%, from 5-10%, from 5-15%, from 10-15%, from 10-20%, or from 10-25%, wt. % relative to the total weight of all pre-ceramic polymers.

Preferred L¹ and L³ groups include C₂₋₆alkylene, C₂₋₅alkylene, C₂₋₄alkylene, C₂₋₃alkylene, C₂alkylene, C₃₋₆alkylene, C₄₋₆alkylene, C₅₋₆alkylene, C₃₋₄alkylene, or C₃₋₅alkylene group. In some embodiments, L¹ is ethylene.

In certain embodiments L² and L⁴ are absent (i.e., null), while in other embodiments, L² and L⁴ can be C₂₋₆alkylene, C₂₋₅alkylene, C₂₋₄alkylene, C₂₋₃alkylene, C₂alkylene, C₃₋₆alkylene, C₄₋₆alkylene, C₅₋₆alkylene, C₃₋₄alkylene, or C₃₋₅alkylene group. Preferably, L² and L⁴ are both null or ethylene.

Z¹ and Z² can be H, OH, OCH₃, NH₂, NHCH₃, N(CH₃)₂, C₁₋₁₀alkyl, aryl, C₁₋₈heterocyclyl, or C₁₋₈heteroaryl, for example an N-heterocycle or N-heteroaryl. A N-heterocycle is a non-aromatic cyclic ring system having at least one nitrogen in the ring system, a N-heteroaryl is an aromatic cyclic ring system having at least one nitrogen in the ring system.

Exemplary N-heteroaryls include pyridyl, imidazidyl, benzimidazidyl, quinolinyl, pyrimidinyl, oxazolyl, thiazolyl, pyridazinyl, indozylyl, bispyridinyl, phenanthrolinyl, or purinyl.

The mixture may include pre-ceramic polymer and transition metal salt in a molar ratio of 20:1 to 1:20, of 10:1 to 1:10, of 5:1 to 1:5, of 2.5:1 to 1:2.5, of 20:1 to 1:10, of 20:1 to 1:5, of 20:1 to 1:2.5, of 20:1 to 1:1, of 20:1 to 2.5:1, of 20:1 to 5:1, of 20:1 to 10:1, of 10:1 to 1:1, of 10:1 to 2.5:1, of 10:1 to 5:1, of 5:1 to 1:1, of 5:1 to 2.5:1, of 1:1 to 1:20, of 1:2.5 to 1:20, of 1:5 to 1:20, of 1:10 to 1:20, of 1:1 to 1:20, of 1:2.5 to 1:10, of 1:5 to 1:10, of 1:1 to 1:5, or from 1:2.5 to 1:5.

The mixture may further include a solvent, for instance a high boiling solvent. High boiling solvents include those having a boiling point (at 1 atm) of at least 150° C., at least 175° C., at least 200° C., at least 225° C., at least 250° C., at least 275° C., at least 300° C., at least 325° C., at least 350° C., at least 375° C., or at least 400° C. Suitable solvents include compounds having the general formula P(C₄₋₁₂alkyl)₃, P(═O)(C₄₋₁₂alkyl)₃, N(C₄₋₁₂alkyl)₃, HN(C₈₋₂₀alkyl)₂, H₂N(C₁₂₋₂₅alkyl), and C₁₄₋₂₅hydrocarbons.

The mixture can include the pre-ceramic polymer and a solvent in a weight ratio of 20:1 to 1:20, of 10:1 to 1:10, of 5:1 to 1:5, of 2.5:1 to 1:2.5, of 20:1 to 1:10, of 20:1 to 1:5, of 20:1 to 1:2.5, of 20:1 to 1:1, of 20:1 to 2.5:1, of 20:1 to 5:1, of 20:1 to 10:1, of 10:1 to 1:1, of 10:1 to 2.5:1, of 10:1 to 5:1, of 5:1 to 1:1, of 5:1 to 2.5:1, of 1:1 to 1:5, of 1:1 to 1:100, of 1:1 to 1:50. of 1:1 to 1:30, of 1:1 to 1:20, of 1:2.5 to 1:20, of 1:5 to 1:20, of 1:10 to 1:100, of 1:10 to 1:50. of 1:10 to 1:30, of 1:10 to 1:20, of 1:1 to 1:20, of 1:2.5 to 1:10, of 1:5 to 1:10, of 1:1 to 1:5, or from 1:2.5 to 1:5.

The mixture can include a transition metal salt and a solvent in a molar ratio of 1:10 to 1:500, of 1:25-1:500, of 1:50 to 1:500, of 1:70-1:500, of 1:100 to 1:500, of 1:125-1:500, of 1:150 to 1:500, of 1:200-1:500, of 1:300 to 1:500, of 1:400-1:500, of 1:10 to 1:100, of 1:50-1:150, of 1:50-1:200 of 1:50-1:250, of 1:100-1:250, or of 1:150-1:300.

Also disclosed herein is a ceramic matrix, prepared by the method described herein. The ceramic matrix may include a first portion of a carbonaceous material and a second portion of a siliconaceous material. The ceramic matrix may also include a third portion that is metal nanoparticles, for example metal sulfide nanoparticles, metal oxide nanoparticle, metal carbide nanoparticles, or a combination thereof. Exemplary metal nanoparticles include copper (I) sulfide nanoparticles, copper (II) sulfide nanoparticles, hafnium sulfide nanoparticles, hafnium oxide nanoparticles, hafnium carbide nanoparticles, or a combination thereof. The metal nanoparticles can be present in an amount from 0.1-50%, from 0.1-25%, from 0.1-10%, from 0.1-5%, from 0.1-2.5%, from 0.1-1%, from 1-5%, from 2.5-7.5%, from 5-10%, from 5-25%, from 10-25%, from 5-50%, from 10-50%, or from 25-50% wt. %, relative to the total weight of the ceramic matrix.

The ceramic matrix discloses herein can be in the form of particles, for instance having an average particle size from 1-50,000 nm, from 1-25,000 nm, from 1-10,000 nm, from 1-5,000 nm, from 1-2,500 nm, from 1-2,000 nm, from 1-1,500 nm, from 1-1,000 nm, from 1-750 nm, from 1-500 nm, from 1-250 nm, from 1-200 nm, from 1-150 nm, from 1-100 nm, from 1-75 nm, from 1-50 nm, from 1-25 nm, from 50-50,000 nm, from 100-50,000 nm, from 500-50,000 nm, from 1,000-50,000 nm, from 2,500-50,000 nm, from 5,000-50,000 nm, from 10,000-50,000 nm, from 25,000-50,000 nm, from 15,000-35,000 nm, from 10,000-25,000 nm, from 5,000-20,000 nm, from 5,000-15,000 nm, from 2,500-15,000 nm, from 2,500-10,000 nm, from 1,000-7,500 nm, from 1,000-5,000 nm, from 500-5,000 nm, from 500-2,500 nm., from 500-1,500 nm, from 250-1,500 nm, from 250-1,000 nm, or from 250-750 nm.

In some instances, the carbonaceous material is not bonded to any non-carbon atoms. Suitable carbonaceous materials include turbostratic carbon, amorphous carbon, graphemic carbon, graphitic carbon, or a combination thereof. For example, having comprises amorphous carbon in an amount. less than 25%, less than 10%, less than 5%, less than 2.5%, less than 1.0, less than 0.5%, less than 0.1% by weight relative to the total amount carbonaceous material. In certain embodiments, the carbonaceous material is graphite. In certain embodiments the carbonaceous material is crystalline, for example at least 50%, at least 75%, at least 90%, at least 95%, at least 97.5%, at least 99%, at least 99.5%, or at least 99.9% by weight of the carbonaceous material can be in the crystalline phase.

The carbonaceous material may be characterized by the relative proportion of sp³ hybridized carbon atoms, which may be present in an amount less than 25%, less than 10%, less than 5%, less than 2.5%, less than 1%, less than 0.5%, or less than 0.1%, relative to the total amount of carbon atoms in the carbonaceous material.

The siliconaceous material in the ceramic matrix can be silicon oxide, silicon carbide, silicon oxycarbide, silicon nitride, silicon oxycarbonitride, silicon boride, silicon boron nitride, or a combination thereof. The siliconaceous material can be present in the crystalline state in an amount of at least 50%, at least 75%, at least 90%, at least 95%, at least 97.5%, at least 99%, at least 99.5%, or at least 99.9% by weight, relative to the total weight of the siliconaceous material.

The ceramic matrix is porous, and in certain embodiments has an average pore size from 0.1-100 μm, from 0.1-75 μm, from 0.1-50 μm, from 0.1-25 μm, from 0.1-10 μm, from 0.1-5 μm, from 0.1-1 μm, from 1-10 μm, from 2.5-15 μm, from 5-20 μm, from 10-25 μm, from 15-50 μm, from 25-75 μm, or from 50-100 μm. from 0.1-100 μm, from 0.1-100 μm, or from 0.1-100 μm.

The ceramic matrix can have a density from 1.0-5.0 g/ml, from 1.0-4.5 g/ml, from 1.0-4.0 g/ml, from 1.0-3.5 g/ml, from 1.0-3.0 g/ml, from 1.0-2.5 g/ml, from 1.0-2.0 g/ml, from 1.0-1.5 g/ml, from 2.0-5.0 g/ml, from 2.0-4.5 g/ml, from 2.0-4.0 g/ml, from 2.0-3.5 g/ml, from 2.0-3.0 g/ml, from 2.0-2.5 g/ml, from 2.25-5.0 g/ml, from 2.25-4.5 g/ml, from 2.25-4.0 g/ml, from 2.25-3.5 g/ml, from 2.25-3.0 g/ml, from 2.25-2.5 g/ml, from 2.5-5.0 g/ml, from 2.5-4.5 g/ml, from 2.5-4.0 g/ml, from 2.5-3.5 g/ml, from 2.5-3.0 g/ml, from 2.75-5.0 g/ml, from 2.75-4.5 g/ml, from 2.75-4.0 g/ml, from 2.75-3.5 g/ml, from 2.75-3.0 g/ml, from 3.0-5.0 g/ml, from 3.0-4.5 g/ml, from 3.0-4.0 g/ml, or from 3.0-3.5 g/ml.

### Further Embodiments

A method of preparing ceramic matrix, comprising subjecting a mixture to a thermolysis step to provide a plurality of nanostructures, and then subjecting the nanostructures to a pyrolysis step to provide a ceramic matrix.

The method according to any preceding embodiment, wherein the thermolysis step comprises a first heating at a first gradient to a first sustained temperature, and then maintaining the temperature at the first sustained temperature for a first period of time.

The method according to any preceding embodiment, wherein the first gradient is from 1-15° C./min, from 1-10° C./min, from 1-8° C./min, from 1-5° C./min, from 2-15° C./min, from 2-10° C./min, from 2-8° C./min, from 2-6° C./min, from 5-15° C./min, or from 5-10° C./min.

The method according to any preceding embodiment, wherein the first sustained temperature from 100-350° C., from 125-350° C., from 150-350° C., from 175-350° C., from 200-350° C., from 225-350° C., from 250-350° C., from 100-300° C., from 100-275° C., from 100-250° C., from 100-225° C., from 100-200° C., from 125-250° C., from 150-250° C., from 150-225° C., from 150-200° C., from 150-175° C., from 175-250° C., from 175-225° C., from 175-200° C., or from 200-225° C.

The method according to any preceding embodiment, wherein the first period of time is 5-250 minutes, from 10-250 minutes, from 20-250 minutes, from 30-250 minutes, from 30-200 minutes, from 30-150 minutes, from 30-120 minutes, from 30-110 minutes, from 30-100 minutes, from 30-90 minutes, from 40-90 minutes, from 50-90 minutes, from 30-75 minutes, from 30-60 minutes, from 30-45 minutes, from 20-40 minutes, from 15-30 minutes, from 10-25 minutes, from 5-20 minutes, from 5-15 minutes, from 1-10 minutes, from 40-80 minutes, or from 45-75 minutes.

The method according to any preceding embodiment, wherein the thermolysis step is conducted in an inert atmosphere, an oxidizing atmosphere, carbonizing atmosphere, or a reducing atmosphere.

The method according to any preceding embodiment, wherein the thermolysis step is conducted in an inert atmosphere comprising argon or nitrogen gas, an oxidizing atmosphere comprises oxygen gas, a carbonizing atmosphere comprising methane gas, ethane gas, ethylene gas, or acetylene gas, or a reducing atmosphere comprising hydrogen gas.

The method according to any preceding embodiment, wherein the pyrolysis step comprises a second heating at a second gradient to a second sustained temperature, and then maintaining the temperature at the second sustained temperature for a second period of time.

The method according to any preceding embodiment, wherein the second gradient is from 1-15° C./min, from 1-10° C./min, from 1-8° C./min, from 1-5° C./min, from 2-15° C./min, from 2-10° C./min, from 2-8° C./min, from 2-6° C./min, from 5-15° C./min, or from 5-10° C./min.

The method according to any preceding embodiment, wherein the second sustained temperature from 300-1,800° C., from 400-1,800° C., from 500-1,800° C., from 600-1,800° C., from 700-1,800° C., from 800-1,800° C., from 900-1,800° C., from 1,000-1,800° C., from 1,200-1,800° C., from 600-1,500° C., from 600-1,200° C., from 750-1,500° C., from 750-1,200° C., from 900-1,500° C., or from 900-1,200° C.,

The method according to any preceding embodiment, wherein the second period of time is 5-250 minutes, from 10-250 minutes, from 20-250 minutes, from 30-250 minutes, from 30-200 minutes, from 30-150 minutes, from 30-120 minutes, from 30-110 minutes, from 30-100 minutes, from 30-90 minutes, from 40-90 minutes, from 50-90 minutes, from 30-75 minutes, from 30-60 minutes, from 30-45 minutes, from 20-40 minutes, from 15-30 minutes, from 10-25 minutes, from 5-20 minutes, from 5-15 minutes, from 1-10 minutes, from 40-80 minutes, or from 45-75 minutes.

The method according to any preceding embodiment, wherein the pyrolysis step is conducted in an inert atmosphere, an oxidizing atmosphere, carbonizing atmosphere, or a reducing atmosphere.

The method according to any preceding embodiment, wherein the pyrolysis step is conducted in an inert atmosphere comprising argon or nitrogen gas, an oxidizing atmosphere comprises oxygen gas, a carbonizing atmosphere comprising methane gas, ethane gas, ethylene gas, or acetylene gas, or a reducing atmosphere comprising hydrogen gas.

The method according to any preceding embodiment, wherein there is no cooling step between the first sustained temperature and the second heating step, or wherein after the first sustained heating step the mixture is cooled to a temperature below the first sustained temperature before commencing the second heating step.

The method according to any preceding embodiment, wherein after the first sustained heating step the mixture is cooled to a temperature that is at least 10% less, at least 20% less, at least 30% less, at least 40% less, at least 50% less, at least 60% less, at least 70% less, at least 80% less, or at least 90% less than the first sustained temperature before commencing the second heating step.

The method according to any preceding embodiment, wherein after the first sustained heating step the mixture is cooled to room temperature before commencing the second heating step.

The method according to any preceding embodiment, wherein the nanostructures are in the shape of spheres or plates.

The method according to any preceding embodiment, wherein the nanostructures are in the shape of spheres having an average diameter from 1-500 nm, from 1-250 nm, from 1-200 nm, from 1-150 nm, from 1-100 nm, from 1-75 nm, from 1-50 nm, from 1-25 nm, from 2-25 nm, from 4-25 nm, from 4-20 nm, from 4-15 nm, from 10-25 nm, from 15-50 nm, from 25-75 nm, or from 25-100 nm.

The method according to any preceding embodiment, wherein the nanostructures are in the shape of plates having an aspect ratio from 1-3.0, from 1-2.5, from 1-2.25, from 1-2, from 1-1.75, from 1-1.50, from 1-1.40, from 1-1.35, from 1-1.25, from 1.05-1.5, from 1.05-1.25, from 1.05-1.15, from 1.1-1.5, from 1.1-1.25, from 1.1-1.15, from 1.15-1.35, from 1.15-1.3, or from 1.15-1.25.

The method according to any preceding embodiment, wherein the nanostructures are in the shape of plates having a thickness from 1-200 nm, from 1-150 nm, from 1-125 nm, from 1-100 nm, from 1-75 nm, from 1-50 nm, from 1-40 nm, from 1-30 nm, from 1-25 nm, from 1-20 nm, from 1-15 nm, from 1-10 nm, from 1-5 nm, from 5-10 nm, from 5-15 nm, from 5-25 nm, from 10-25 nm, from 10-50 nm, from 25-75 nm, or from 50-100 nm.

The method according to any preceding embodiment, wherein the mixture comprises at least one pre-ceramic polymer and one transition metal salt.

The method according to any preceding embodiment, wherein the mixture comprises one or more salts of Cu⁺¹, Cu⁺², Hf⁴, Fe⁺¹, Fe⁺², Fe⁺³, Co⁺², Co⁺³, Ni⁺², Ni⁺³, Ni⁺⁴, Nb⁺², Nb⁺³, Nb⁺⁴, Nb⁺⁵, Mo⁺², Mo⁺³, Mo⁺⁴, Mo⁺⁵, and Mo⁺⁶.

The method according to any preceding embodiment, wherein the mixture comprises a Cu⁺² salt.

The method according to any preceding embodiment, wherein the mixture comprises CuCl₂, Cu(acac)₂, CuO, CuSO₄, Cu(OAc)₂, CuCO₃, CuBr₂, Cu₃(PO₄)₂, Cu(OBz)₂, HfCl₄,

The method according to any preceding embodiment, wherein the mixture comprises a pre-ceramic polymer of Formula (I):

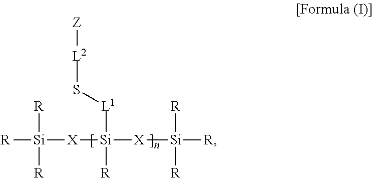

wherein:
R is H, C₁₋₈alkyl, aryl, C₃₋₈cycloalkyl, C₁₋₈heterooalkyl, or C₃₋₈heteroaryl,
X is null, CH₂, —O—, —N(R′)—, —B(R²)—, —Si(R)₂CH₂—, —N═C═N—, —O—Si—B(R²)—,
R¹ is independently selected from H, C₁₋₃alkyl, B(R²)₂, and -L¹-S-L²-Z,
R² is independently selected from H, C₁₋₃alkyl, and -L¹-S-L²-Z,
n is selected from 10-500, 10-25, 10-50, 10-100, 100-500, 100-250, 250-500, 25-150, 25-100, 25-75, 25-50, 50-75, or 50-100;
L¹ is in each case independently selected from null, C₁₋₈alkylene, arylene, C₃₋₈cycloalkylene, C₁₋₈heteroarylene, or C₁₋₈heterocyclylene;
L² is in each case independently selected from null, C₁₋₈alkylene, arylene, C₃₋₈cycloalkylene, C₁₋₈heteroarylene, or C₁₋₈heterocyclylene; and
Z is in each case independently selected from Z¹, OZ¹, N(Z¹)₂, C(O)Z¹, C(O)OZ¹, C(O)N(Z¹)₂, where Z¹ is in case selected from H, C₁₋₁₂alkyl, aryl, C₃₋₈cycloalkyl, C₁₋₈heteroaryl, and C₁₋₈heterocyclyl.

The method according to any preceding embodiment, wherein R is methyl, ethyl, isopropyl, n-propyl, n-butyl, sec-butyl tert-butyl, isobutyl, pentyl, hexyl, cyclopropyl, cyclobutyl, cyclopentyl, cyclohexyl, or phenyl.

The method according to any preceding embodiment, wherein R is methyl.

The method according to any preceding embodiment, wherein the mixture comprises a pre-ceramic polymer of Formula (II):

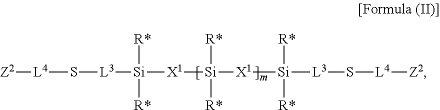

or a combination thereof,
wherein:
R* is H, C₁₋₈alkyl, aryl, C₃₋₈cycloalkyl, C₁₋₈heterooalkyl, or C₃₋₈heteroaryl,
X¹ is null, CH₂, —O—, —N(R³)—, —B(R⁴)—, —Si(R)₂CH₂—, —N═C═N—, —O—Si—B(R⁴)—,
R³ is independently selected from H, C₁₋₃alkyl, and B(R⁴)₂,
R⁴ is H or C₁₋₃alkyl,
m is in each case independently selected from 10-500, 10-25, 10-50, 10-100, 100-500, 100-250, 250-500, 25-150, 25-100, 25-75, 25-50, 50-75, or 50-100;
L³ is in each case independently selected from null, C₁₋₈alkylene, arylene, C₃₋₈cycloalkylene, C₁₋₈heteroarylene, or C₁₋₈heterocyclylene;
L⁴ is in each case independently selected from null, C₁₋₈alkylene, arylene, C₃₋₈cycloalkylene, C₁₋₈heteroarylene, or C₁₋₈heterocyclylene; and
Z² is in each case independently selected from Z³, OZ³, N(Z³)₂, C(O)Z³, C(O)OZ³, C(O)N(Z³)₂, where Z³ is in case selected from H, C₁₋₁₂alkyl, aryl, C₃₋₈cycloalkyl, C₁₋₈heteroaryl, and C₁₋₈heterocyclyl.

The method according to any preceding embodiment, wherein R* is methyl, ethyl, isopropyl, n-propyl, n-butyl, sec-butyl tert-butyl, isobutyl, pentyl, hexyl, cyclopropyl, cyclobutyl, cyclopentyl, cyclohexyl, or phenyl.

The method according to any preceding embodiment, wherein R* is methyl.

The method according to any preceding embodiment, wherein the mixture does not contain any compound of Formula (II), or contains at least one compound of Formula (II) in an amount that is from 0.1-50%, from 0.5-50%, from 1-50%, from 1-25%, from 1-15%, from 1-10%, from 1-5%, from 0.1-1%, from 0.5-5%, from 0.5-2.5%, from 5-10%, from 5-15%, from 10-15%, from 10-20%, or from 10-25%, wt. % relative to the total weight of all pre-ceramic polymers.

The method according to any preceding embodiment, wherein L¹ is in case independently a C₂₋₆alkylene, C₂₋₅alkylene, C₂₋₄alkylene, C₂₋₃alkylene, C₂alkylene, C₃₋₆alkylene, C₄₋₆alkylene, C₅₋₆alkylene, C₃₋₄alkylene, or C₃₋₅alkylene group.

The method according to any preceding embodiment, wherein L² is in case independently null or a C₂₋₆alkylene, C₂₋₅alkylene, C₂₋₄alkylene, C₂₋₃alkylene, C₂alkylene, C₃₋₆alkylene, C₄₋₆alkylene, C₅₋₆alkylene, C₃₋₄alkylene, or C₃₋₅alkylene group.

The method according to any preceding embodiment, wherein L¹ is ethylene.

The method according to any preceding embodiment, wherein L² is null or ethylene.

The method according to any preceding embodiment, wherein Z¹ is H, OH, OCH₃, NH₂, NHCH₃, N(CH₃)₂, C₁₋₁₀alkyl, aryl, or C₁₋₈heteroaryl.

The method according to any preceding embodiment, wherein Z¹ is an N-heteroaryl.

The method according to any preceding embodiment, wherein Z¹ is pyridyl, imidazidyl, benzimidazidyl, quinolinyl, pyrimidinyl, oxazolyl, thiazolyl, pyridazinyl, indozylyl, bispyridinyl, phenanthrolinyl, or purinyl.

The method according to any preceding embodiment, wherein L³ is in case independently a C₂₋₆alkylene, C₂₋₅alkylene, C₂₋₄alkylene, C₂₋₃alkylene, C₂alkylene, C₃₋₆alkylene, C₄₋₆alkylene, C₅₋₆alkylene, C₃₋₄alkylene, or C₃₋₅alkylene group.

The method according to any preceding embodiment, wherein L⁴ is in case independently null or a C₂₋₆alkylene, C₂₋₅alkylene, C₂₋₄alkylene, C₂₋₃alkylene, C₂alkylene, C₃₋₆alkylene, C₄₋₆alkylene, C₅₋₆alkylene, C₃₋₄alkylene, or C₃₋₅alkylene group.

The method according to any preceding embodiment, wherein L³ is ethylene.

The method according to any preceding embodiment, wherein L⁴ is null or ethylene.

The method according to any preceding embodiment, wherein Z² is H, OH, OCH₃, NH₂, NHCH₃, N(CH₃)₂, C₁₋₁₀alkyl, aryl, or C₁₋₈heteroaryl.

The method according to any preceding embodiment, wherein Z² is an N-heteroaryl.

The method according to any preceding embodiment, wherein Z² is pyridyl, imidazidyl, benzimidazidyl, quinolinyl, pyrimidinyl, oxazolyl, thiazolyl,

The method according to any preceding embodiment, wherein the mixture comprises pre-ceramic polymer and transition metal salt in a molar ratio of 20:1 to 1:20, of 10:1 to 1:10, of 5:1 to 1:5, of 2.5:1 to 1:2.5, of 20:1 to 1:10, of 20:1 to 1:5, of 20:1 to 1:2.5, of 20:1 to 1:1, of 20:1 to 2.5:1, of 20:1 to 5:1, of 20:1 to 10:1, of 10:1 to 1:1, of 10:1 to 2.5:1, of 10:1 to 5:1, of 5:1 to 1:1, of 5:1 to 2.5:1, of 1:1 to 1:20, of 1:2.5 to 1:20, of 1:5 to 1:20, of 1:10 to 1:20, of 1:1 to 1:20, of 1:2.5 to 1:10, of 1:5 to 1:10, of 1:1 to 1:5, or from 1:2.5 to 1:5.

The method according to any preceding embodiment, wherein the mixture further comprises a solvent.

The method according to any preceding embodiment, wherein the mixture comprises a solvent having a boiling point (at 1 atm) of at least 150° C., at least 175° C., at least 200° C., at least 225° C., at least 250° C., at least 275° C., at least 300° C., at least 325° C., at least 350° C., at least 375° C., or at least 400° C.

The method according to any preceding embodiment, wherein the mixture comprises a solvent, wherein the solvent comprises P(C₄₋₁₂alkyl)₃, P(═O)(C₄₋₁₂alkyl)₃, N(C₄₋₁₂alkyl)₃, HN(C₈₋₂₀alkyl)₂, H₂N(C₁₂₋₂₅alkyl), C₁₄₋₂₅hydrocarbons, or a combination thereof.

The method according to any preceding embodiment, wherein the mixture comprises pre-ceramic polymer and a solvent in a weight ratio of 20:1 to 1:20, of 10:1 to 1:10, of 5:1 to 1:5, of 2.5:1 to 1:2.5, of 20:1 to 1:10, of 20:1 to 1:5, of 20:1 to 1:2.5, of 20:1 to 1:1, of 20:1 to 2.5:1, of 20:1 to 5:1, of 20:1 to 10:1, of 10:1 to 1:1, of 10:1 to 2.5:1, of 10:1 to 5:1, of 5:1 to 1:1, of 5:1 to 2.5:1, of 1:1 to 1:5, of 1:1 to 1:100, of 1:1 to 1:50. of 1:1 to 1:30, of 1:1 to 1:20, of 1:2.5 to 1:20, of 1:5 to 1:20, of 1:10 to 1:100, of 1:10 to 1:50. of 1:10 to 1:30, of 1:10 to 1:20, of 1:1 to 1:20, of 1:2.5 to 1:10, of 1:5 to 1:10, of 1:1 to 1:5, or from 1:2.5 to 1:5.

The method according to any preceding embodiment, wherein the mixture comprises a transition metal salt and a solvent in a molar ratio of 1:10 to 1:500, of 1:25-1:500, of 1:50 to 1:500, of 1:70-1:500, of 1:100 to 1:500, of 1:125-1:500, of 1:150 to 1:500, of 1:200-1:500, of 1:300 to 1:500, of 1:400-1:500, of 1:10 to 1:100, of 1:50-1:150, of 1:50-1:200 of 1:50-1:250, of 1:100-1:250, or of 1:150-1:300.

A ceramic matrix, prepared by the method according to any preceding embodiment.

A ceramic matrix, comprising a first portion comprising a carbonaceous material, a second portion comprising a siliconaceous material.

The ceramic matrix according to any preceding embodiment, in the form of particles.

The ceramic matrix according to any preceding embodiment, in the form of particles having an average particle size from 1-50,000 nm, from 1-25,000 nm, from 1-10,000 nm, from 1-5,000 nm, from 1-2,500 nm, from 1-2,000 nm, from 1-1,500 nm, from 1-1,000 nm, from 1-750 nm, from 1-500 nm, from 1-250 nm, from 1-200 nm, from 1-150 nm, from 1-100 nm, from 1-75 nm, from 1-50 nm, from 1-25 nm, from 50-50,000 nm, from 100-50,000 nm, from 500-50,000 nm, from 1,000-50,000 nm, from 2,500-50,000 nm, from 5,000-50,000 nm, from 10,000-50,000 nm, from 25,000-50,000 nm, from 15,000-35,000 nm, from 10,000-25,000 nm, from 5,000-20,000 nm, from 5,000-15,000 nm, from 2,500-15,000 nm, from 2,500-10,000 nm, from 1,000-7,500 nm, from 1,000-5,000 nm, from 500-5,000 nm, from 500-2,500 nm., from 500-1,500 nm, from 250-1,500 nm, from 250-1,000 nm, or from 250-750 nm.

The ceramic matrix according to any preceding embodiment, further comprising a third portion comprising metal nanoparticles.

The ceramic matrix according to any preceding embodiment, further comprising a third portion comprising metal sulfide nanoparticles, metal oxide nanoparticle, metal carbide nanoparticles, or a combination thereof.

The ceramic matrix according to any preceding embodiment, further comprising a third portion comprising copper (I) sulfide nanoparticles, copper (II) sulfide nanoparticles, hafnium sulfide nanoparticles, hafnium oxide nanoparticles, hafnium carbide nanoparticles, or a combination thereof.

The ceramic matric according to any preceding embodiment, wherein the metal sulfide nanoparticles are present in an amount from 0.1-50%, from 0.1-25%, from 0.1-10%, from 0.1-5%, from 0.1-2.5%, from 0.1-1%, from 1-5%, from 2.5-7.5%, from 5-10%, from 5-25%, from 10-25%, from 5-50%, from 10-50%, or from 25-50% wt. %, relative to the total weight of the ceramic matrix.

The ceramic matrix according to any preceding embodiment, wherein the carbonaceous material is not bonded to any non-carbon atoms.

The ceramic matrix according to any preceding embodiment, wherein the carbonaceous material comprises turbostratic carbon, amorphous carbon, graphemic carbon, graphitic carbon, or a combination thereof.

The ceramic matrix according to any preceding embodiment, wherein carbonaceous material comprises less than 25%, less than 10%, less than 5%, less than 2.5%, less than 1%, less than 0.5%, or less than 0.1% sp³ hybridized carbon atoms, relative to the total amount of carbon atoms in the carbonaceous material.

The ceramic matrix according to any preceding embodiment, wherein carbonaceous material comprises graphite.

The ceramic matrix according to any preceding embodiment, wherein carbonaceous material comprises amorphous carbon in an amount. less than 25%, less than 10%, less than 5%, less than 2.5%, less than 1.0, less than 0.5%, less than 0.1% by weight relative to the total amount carbonaceous material.

The ceramic matrix according to any preceding embodiment, wherein the siliconaceous material comprises silicon oxide, silicon carbide, silicon oxycarbide, silicon nitride, silicon oxycarbonitride, silicon boride, silicon boron nitride, or a combination thereof.

The ceramic matrix according to any preceding embodiment, wherein the siliconaceous material is in the crystalline state in an amount of at least 50%, at least 75%, at least 90%, at least 95%, at least 97.5%, at least 99%, at least 99.5%, or at least 99.9% by weight, relative to the total amount of siliconaceous material.

The ceramic matrix according to any preceding embodiment, wherein the ceramic matrix is porous and has an average pore size from 0.1-100 μm, from 0.1-75 μm, from 0.1-50 μm, from 0.1-25 μm, from 0.1-10 μm, from 0.1-5 μm, from 0.1-1 μm, from 1-10 μm, from 2.5-15 μm, from 5-20 μm, from 10-25 μm, from 15-50 μm, from 25-75 μm, or from 50-100 μm. from 0.1-100 μm, from 0.1-100 μm, or from 0.1-100 μm.

The ceramic matrix according to any preceding embodiment, wherein the ceramic matrix has a density from 1.0-5.0 g/ml, from 1.0-4.5 g/ml, from 1.0-4.0 g/ml, from 1.0-3.5 g/ml, from 1.0-3.0 g/ml, from 1.0-2.5 g/ml, from 1.0-2.0 g/ml, from 1.0-1.5 g/ml, from 2.0-5.0 g/ml, from 2.0-4.5 g/ml, from 2.0-4.0 g/ml, from 2.0-3.5 g/ml, from 2.0-3.0 g/ml, from 2.0-2.5 g/ml, from 2.25-5.0 g/ml, from 2.25-4.5 g/ml, from 2.25-4.0 g/ml, from 2.25-3.5 g/ml, from 2.25-3.0 g/ml, from 2.25-2.5 g/ml, from 2.5-5.0 g/ml, from 2.5-4.5 g/ml, from 2.5-4.0 g/ml, from 2.5-3.5 g/ml, from 2.5-3.0 g/ml, from 2.75-5.0 g/ml, from 2.75-4.5 g/ml, from 2.75-4.0 g/ml, from 2.75-3.5 g/ml, from 2.75-3.0 g/ml, from 3.0-5.0 g/ml, from 3.0-4.5 g/ml, from 3.0-4.0 g/ml, or from 3.0-3.5 g/ml.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A method of preparing ceramic matrix, comprising subjecting a mixture to a thermolysis step to provide a plurality of nanostructures, and then subjecting the nanostructures to a pyrolysis step to provide a ceramic matrix,
wherein the mixture comprises at least one pre-ceramic polymer and one transition metal salt.

2. The method according to claim 1, wherein the thermolysis step comprises a first heating at a first gradient to a first sustained temperature, and then maintaining the temperature at the first sustained temperature for a first period of time, wherein the first sustained temperature is from 125-250° C.

3-7. (canceled)

8. The method according to claim 1, wherein the pyrolysis step comprises a second heating at a second gradient to a second sustained temperature, and then maintaining the temperature at the second sustained temperature for a second period of time, wherein the second sustained temperature is from 700-1,800° C.

9-17. (canceled)

18. The method according to claim 1, wherein the nanostructures are in the shape of spheres having an average diameter from from 4-25 nm.

19. The method according to claim 1, wherein the nanostructures are in the shape of plates having an aspect ratio from 1-3.0.

20. The method according to claim 1, wherein the nanostructures are in the shape of plates having a thickness from 1-200 nm.

21. (canceled)

22. The method according to claim 1, wherein the mixture comprises one or more salts of Cu⁺¹, Cu⁺², Hf⁺⁴, Fe⁺¹, Fe⁺², Fe⁺³, Co⁺², Co⁺³, Ni⁺², Ni⁺³, Ni⁺⁴, Nb⁺², Nb⁺³, Nb⁺⁴, Nb⁺⁵, Mo⁺², Mo⁺³, Mo⁺⁴, Mo⁺⁵, and Mo⁺⁶.

23. The method according to claim 1, wherein the mixture comprises a Cu⁺² salt.

24. (canceled)

25. The method according to claim 1, wherein the mixture comprises a pre-ceramic polymer of Formula (I): 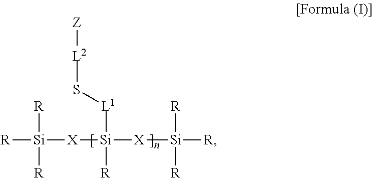
wherein:
R is H, C₁₋₈alkyl, aryl, C₃₋₈cycloalkyl, C₁₋₈heterooalkyl, or C₃₋₈heteroaryl,
X is null, CH₂, —O—, —N(R′)—, —B(R²)—, —Si(R)₂CH₂—, —N═C═N—, —O—Si—B(R²)—,
R¹ is independently selected from H, C₁₋₃alkyl, B(R²)₂, and -L¹-S-L²-Z,
R² is independently selected from H, C₁₋₃alkyl, and -L¹-S-L²-Z,
n is selected from 10-500;
L¹ is in each case independently selected from null, C₁₋₈alkylene, arylene, C₃₋₈cycloalkylene, C₁₋₈heteroarylene, or C₁₋₈heterocyclylene;
L² is in each case independently selected from null, C₁₋₈alkylene, arylene, C₃₋₈cycloalkylene, C₁₋₈heteroarylene, or C₁₋₈heterocyclylene; and
Z is in each case independently selected from Z¹, OZ¹, N(Z¹)₂, C(O)Z¹, C(O)OZ¹, C(O)N(Z¹)₂, where Z¹ is in case selected from H, C₁₋₁₂alkyl, aryl, C₃₋₈cycloalkyl, C₁₋₈heteroaryl, and C₁₋₈heterocyclyl.

26. (canceled)

27. The method according to claim 25, wherein R is methyl.

28. The method according to claim 25, wherein the mixture comprises a pre-ceramic polymer of Formula (II): 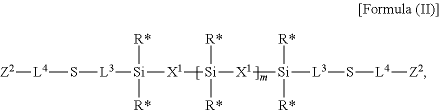
wherein:
R* is H, C₁₋₈alkyl, aryl, C₃₋₈cycloalkyl, C₁₋₈heterooalkyl, or C₃₋₈heteroaryl,
X¹ is null, CH₂, —O—, —N(R³)—, —B(R⁴)—, —Si(R)₂CH₂—, —N═C═N—, —O—Si—B(R⁴)—,
R³ is independently selected from H, C₁₋₃alkyl, and B(R⁴)₂,
R⁴ is H or C₁₋₃alkyl,
m is in each case independently selected from 10-500;
L³ is in each case independently selected from null, C₁₋₈alkylene, arylene, C₃₋₈cycloalkylene, C₁₋₈heteroarylene, or C₁₋₈heterocyclylene;
L⁴ is in each case independently selected from null, C₁₋₈alkylene, arylene, C₃₋₈cycloalkylene, C₁₋₈heteroarylene, or C₁₋₈heterocyclylene; and
Z² is in each case independently selected from Z³, OZ³, N(Z³)₂, C(O)Z³, C(O)OZ³, C(O)N(Z³)₂, where Z³ is in case selected from H, C₁₋₁₂alkyl, aryl, C₃₋₈cycloalkyl, C₁₋₈heteroaryl, and C₁₋₈heterocyclyl.

29. (canceled)

30. The method according to claim 28, wherein R* is methyl.

31. The method according to claim 28, wherein the mixture contains at least one compound of Formula (II) in an amount that is from 0.1-50 wt. % relative to the total weight of all pre-ceramic polymers.

32-36. (canceled)

37. The method according to claim 25, wherein Z¹ is an N-heteroaryl.

38-43. (canceled)

44. The method according to claim 28, wherein Z² is an N-heteroaryl.

45-47. (canceled)

48. The method according to claim 1, wherein the mixture comprises a solvent having a boiling point (at 1 atm) of at least 200° C.

49. The method according claim 1, wherein the mixture comprises a solvent, wherein the solvent comprises P(C₄₋₁₂alkyl)₃, P(═O)(C₄₋₁₂alkyl)₃, N(C₄₋₁₂alkyl)₃, HN(C₈₋₂₀alkyl)₂, H₂N(C₂₋₂₅alkyl), C₁₄₋₂₅hydrocarbons, or a combination thereof.

50-51. (canceled)

52. A ceramic matrix, prepared by the method according to claim 1.

53. A ceramic matrix, comprising a first portion comprising a carbonaceous material, a second portion comprising a siliconaceous material.

54-68. (canceled)
